(19) United States
(12) Patent Application Publication
(10) Pub. No.: US 2013/0132413 A1
(43) Pub. Date: May 23, 2013

(54) APPARATUS AND METHODS FOR CREATING COMBINED SPACE OF INTEREST OBJECT AND CONTENTS

(71) Applicants: Cheol-Woo Park, Seoul (KR); Soon-Sung Kwon, Anyang (KR); Hyun Mi Kim, Uiwang (KR)

(72) Inventors: Cheol-Woo Park, Seoul (KR); Soon-Sung Kwon, Anyang (KR); Hyun Mi Kim, Uiwang (KR)

(73) Assignee: HYUNDAI MOTOR COMPANY, Seoul (KR)

(21) Appl. No.: 13/619,218

(22) Filed: Sep. 14, 2012

Related U.S. Application Data
(63) Continuation-in-part of application No. 13/320,649, filed on Nov. 15, 2011.
(60) Provisional application No. 61/591,053, filed on Jan. 26, 2012.

(30) Foreign Application Priority Data
May 15, 2009 (KR) 10-2009-0042401

(51) Int. Cl. G06F 17/30

(52) U.S. Cl. CPC G06F 17/30386
USPC 707/758

(57) ABSTRACT

One aspect of the invention provides an apparatus for creating a combined SOI object and contents. The apparatus includes: a first creation unit creating uppermost contents including theme information of the combined SOI object; an SOI storage unit storing information on a space including location information, shape information, and identifier information; a lower content storage unit storing a plurality of lower contents; a second creation unit creating lower contents according to a request by a user; and a relationship information creating unit searching the lower contents and the SOI requested by the user in the lower content storage unit and the SOI storage unit and then creating a first relationship information between the uppermost contents and the searched or created lower contents and creating a second relationship information between the uppermost contents and the searched SOI.

### CROSS-REFERENCE TO RELATED APPLICATIONS

This application claims priority under 35 U.S.C.§119(e) to U.S. Provisional Patent Application Ser. No. 61/591,053, filed Jan. 26, 2012. This application is also a continuation-in-part under 35 U.S.C.§120 of U.S. patent application Ser. No. 13/320,649, filed Nov. 15, 2011, which is a national phase application under 35 U.S.C.§371 of International Application No. PCT/KR2010/003055, filed May 14, 2010, which claim priority to Korean Patent Application No. 10-2009-0042401, filed May 15, 2009. The entire content of each of the above-referenced patent applications is hereby is incorporated by reference herein.

### FIELD OF THE INVENTION

The present invention relates to an apparatus and a method for creating a complex space of interest (SOI) object and contents, and more particularly, to an apparatus and a method for creating second relationship information between one space of interest (SOI) including location information, shape information, and identifier information and one content having first relationship information with other contents or other SOIs.

### BACKGROUND OF THE INVENTION

Existing information systems have limited abilities to associate content with geographical information. Although it is possible to associate an HTTP hyperlink with a point of interest, there remains a need for association of geographical information and other content in accordance with an overarching idea.

### SUMMARY OF THE INVENTION

The present invention has been made in an effort to provide an apparatus and a method for creating a complex SOI object and contents capable of increasing link scalability of SOI and contents by creating a second relationship information between one SOI including location information, shape information, and identifier information and one content having a first relationship information with other contents or other SOIs.

One aspect of the invention provides an apparatus for creating a combined SOI object and contents. The apparatus includes: a first creation unit creating uppermost contents including theme information of the combined SOI object; an SOI storage unit storing information on a space including location information, shape information, and identifier information; a lower content storage unit storing a plurality of lower contents; a second creation unit creating lower contents according to a request by a user; and a relationship information creating unit searching the lower contents and the SOI requested by the user in the lower content storage unit and the SOI storage unit and then creating a first relationship information between the uppermost contents and the searched or created lower contents and creating a second relationship information between the uppermost contents and the searched SOI.

In one embodiment, the lower contents are linked with at least one other contents or SOIs. In another embodiment, the relationship information creation unit creates third relationship information between the lower contents and other contents or fourth relationship information between the lower contents and the SOIs.

In another embodiment, the SOI is linked with at least one other contents or other SOIs. In another embodiment, the relationship information creation unit creates fifth relationship information between the SOI and other contents or sixth relationship information between the SOI and other SOIs.

Another aspect of the invention provides a method for creating a complex object of SOI and contents. This method includes: storing information on a space including location information, shape information, and identifier information; storing a plurality of lower contents; creating uppermost contents including theme information of the complex object; and searching the lower contents and the SOI requested in the lower content storage unit and the SOI storage unit and then, creating first relationship information between the uppermost contents and the searched or created lower contents and creating second relationship information between the uppermost contents and the searched SOI.

In one embodiment, the lower contents are linked with at least one other content or SOI. The method can further include creating, by the relationship information creation unit, third relationship information between the lower contents and other contents or fourth relationship information between the lower contents and the SOIs.

In another embodiment, the SOI is linked with at least one other contents or other SOIs. The method can further include creating, by the relationship information creation unit, a fifth relationship information between the SOI and other contents or a sixth relationship information between the SOI and other SOIs.

Another aspect of the invention provides a method of generating a complex object of spaces of interest (SOIs) and contents. The method includes: storing a plurality of SOIs; storing a plurality of contents; and storing a complex object that defines a plurality of relationships between the complex object and a subset of the plurality of contents.

The method can further include displaying the complex object such that the displayed complex object displays at least a portion of the subset of the plurality of the contents.

The method can further include storing a plurality of relationships between one or more of the SOIs and one or more of the contents; displaying a map along with the complex object, the map encompassing an displayed area including one or more SOIs associated with the plurality of the contents; receiving instructions to modify the displayed area of the map; and updating the displayed complex object to display only contents from the subset of contents that are associated with the SOIs within the displayed area.

In another embodiment, the complex object represents a theme.

The method can further include: displaying at least a portion of the complex object when one of either the contents of the subset or the SOIs associated with the contents of the subset is displayed.

Another aspect of the invention provides a computer program product for causing a computer to perform a method for creating a complex object of SOI and contents. The computer program product includes computer-usable medium having control logic stored therein that, when executed by a processor, is operable to: store information on a space including location information, shape information, and identifier information; store a plurality of lower contents; create uppermost contents including theme information of the complex object; and search the lower contents and the SOI requested in the lower content storage unit and the SOI storage unit and then, create first relationship information between the uppermost contents and the searched or created lower contents and create second relationship information between the uppermost contents and the searched SOI.

Another aspect of the invention provides a computer program product for causing a computer to perform a method of generating a complex object of spaces of interest (SOIs) and contents. The computer program product includes computer-usable medium having control logic stored therein that, when executed by a processor, is operable to: store a plurality of SOIs; store a plurality of contents; and store a complex object that defines a plurality of relationships between the complex object and a subset of the plurality of contents.

### BRIEF DESCRIPTION OF THE DRAWINGS

The above and other objects, features and advantages of the present invention will be more apparent from the following detailed description taken in conjunction with the accompanying drawings, in which:

FIG. 1 is a configuration diagram of an apparatus for creating a combined SOI object and contents according to an embodiment of the present invention;

FIG. 2 is a configuration diagram of an apparatus for creating an SOI according to an embodiment of the present invention; and

FIG. 3 is a flow chart of a method for creating a combined SOI object relationship and contents according to an embodiment of the present invention;

FIG. 4 is a flow chart of a method for creating a combined SOI object relationship according to another embodiment of the present invention; and

FIG. 5 depicts an exemplary implementation of a complex object.

### DETAILED DESCRIPTION OF THE PREFERRED EMBODIMENTS

Information is more rapidly spread when the information is transferred in a story type rather than in a fragment type. When a story is coupled with a place, the story can directly be connected with a user's behavior.

An apparatus for creating relationship information using a point of interest (POI) according to the related art simply links a specific POI with a website including detailed information corresponding to the specific POI to create the relationship information.

However, this is a technology based on the POI. Accordingly, a need exists for a new method for creating relationship information based on space of interest (SOI). A space of interest (SOI) refers to a collection of data about a space of people's interest or use. An SOI is made up of point, line and/or plane and has a unique identifying data. An SOI object refers a structure which binds spatial information, identifying data and property information (e.g., color, thickness of line, type of line, time of exposure, allowed time of use, control of permission to access) of an SOI.

Hereinafter, exemplary embodiments of the present invention will be described in detail with reference to the accompanying drawings.

In exemplary embodiments of the present invention, a complex object is a data structure in which SOI and contents are simply or complexly linked with one another, thereby having relationship information, wherein the relationship information includes a relationship order between SOI and contents, time attribute, description for contents, and the like. For example, the complex object can be a special type of SOI and can share one or more attributes of SOIs. For example, complex objects and SOIs can use a single ID scheme.

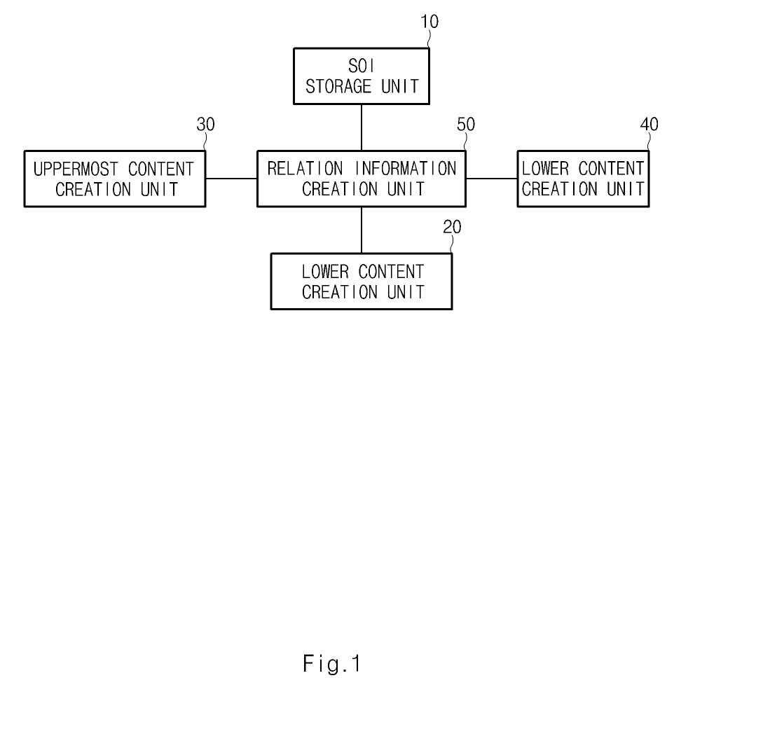

FIG. 1 shows a configuration diagram of an apparatus for creating a complex SOI object and contents according to an embodiment of the present invention.

As shown in FIG. 1, the apparatus for creating a complex SOI object and contents according to an embodiment of the present invention includes an SOI storage unit 10, a lower contents storage unit 20, an uppermost content creation unit 30, a lower content creation unit 40, and a relationship information creation unit 50.

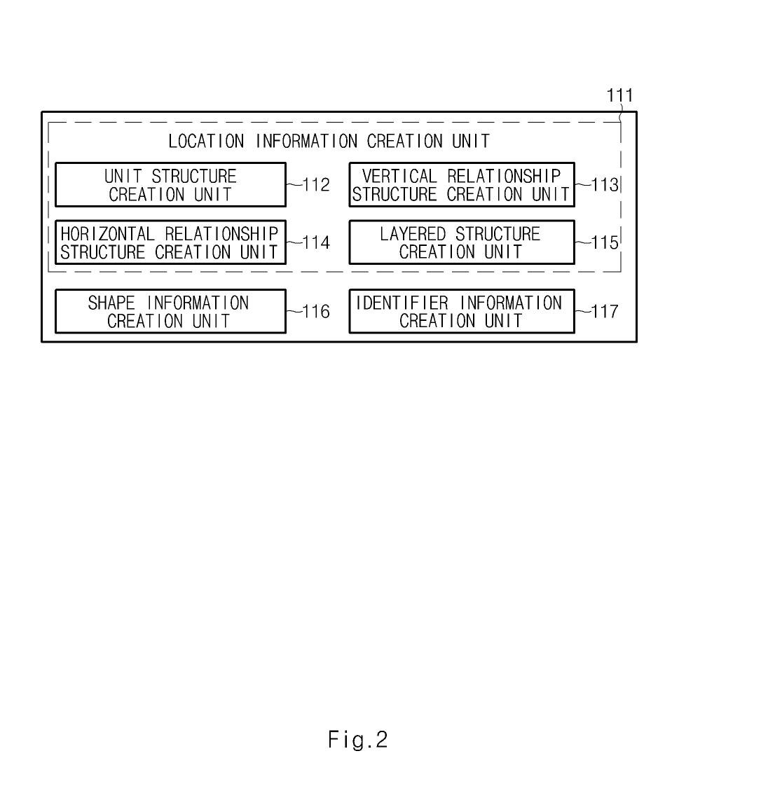

Describing each component, the SOI storage unit 10 first stores information (hereinafter, SOI) on a space including location information, shape information, and identifier information. That is, the SOI storage unit 10 stores a plurality of SOIs. The SOI will be described with reference to FIG. 2.

The lower contents storage unit 20 stores various lower contents that can include texts, images, and moving pictures or a combination of texts, images, and moving pictures, such as blog, news, goods, event, advertisement, and the like. Here, the lower contents refer to all of the contents linked under the uppermost contents created by the uppermost content creation unit 30. In this case, each of the lower contents includes the relationship information with at least one other lower contents or SOIs, thereby making it possible to be linked with other contents or SOIs through one content.

The uppermost content creation unit 30 creates the uppermost contents including theme information of the complex SOI object according to a request of a user.

The lower content creation unit 40 creates the lower contents according to a user's request.

The relationship information creation unit 50 creates the relationship information between the uppermost content created in the uppermost content creation unit 30 and the lower content created in the lower content creation unit 40.

In addition, the relationship information creation unit 50 searches for the lower contents as requested by a user in the lower contents storage unit 20 and searches the SOI requested from the user in the SOI storage unit 10.

Thereafter, the relationship information creation unit 50 creates the relationship information between the uppermost content created in the uppermost content creation unit 30 and the searched lower contents.

In addition, the relationship information creation unit 50 can create the relationship information between the uppermost content created in the uppermost content creation unit 30 and the searched SOI.

In this case, the relationship information creation unit 50 can create first relationship information between the uppermost content created in the uppermost content creation unit 30 and the lower content created in the lower content creation unit 40 and can create second relationship information between the uppermost content created in the uppermost content creation unit 30 and the searched SOI.

In this case, the relationship information creation unit 50 can create the first relationship information between the uppermost content created in the uppermost content creation unit 30 and the searched lower contents and can create the second relationship information between the uppermost content created in the uppermost content creation unit 30 and the searched SOI.

Further, the relationship information creation unit 50 can create another relationship information between other lower contents or other SOIs that can further be linked with one another based on the lower contents linked with the lower contents of the uppermost content created in the uppermost content creation unit 30.

In addition, the relationship information creation unit 50 can create the relationship information between the lower contents or other SOIs that are again linked with one another based on the SOIs linked with the lower contents of the uppermost content created in the uppermost content creation unit 30.

Meanwhile, the relationship information creation unit 50 can change a title and a description of the relationship information according to a user's request.

In addition, the uppermost content creation unit 30, the lower content creation unit 40, and the relationship information creation unit 50 allow an interface with a user through an input unit (not shown in the figure).

For reference, the input unit can selectively receive specific SOIs or specific contents on a list from a user, selectively receive specific SOIs or specific contents on an electronic map from a user, and selectively receive specific SOIs or specific contents through a key input from a user.

Further, the input unit can receive information such as a relationship order, time attribute, description for contents, and the like, from a user. The input information can be included in the relationship information by the relationship information creation unit 50.

FIG. 2 is a configuration diagram of an apparatus for creating SOI according to an embodiment of the present invention.

As shown in FIG. 2, the apparatus for creating SOI used for the embodiment of the present invention includes a location information creation unit 111 for creating location information, SOI structure information, SOI combination information, and the like, on a map, a shape information creation unit 116 for creating shape information such as point, line, and region information, building information, or the like, on the location information, and an identifier information creation unit 117 for creating and allocating identifier information for identifying each SOI.

Here, the location information creation unit 111 creates the location information and creates and manages SOIs for the location information. Further, the location information creation unit 111 manages structural information when the SOIs are created to have a structure and manages combination information when the structures of the SOIs are combined.

The location information creation unit 111 includes a unit structure creation unit 112 for creating and managing a single SOI, a vertical relationship structure creation unit 113 for creating and managing a vertical relationship structure of the SOIs so that the plurality of SOIs are included in a single SOI, a horizontal relationship structure creation unit 114 for creating and managing a horizontal relationship structure of the SOIs so that a plurality of SOIs are connected with one another in parallel, and a layered relationship structure creation unit 115 for creating and managing a layered relationship structure of the SOIs so that the plurality of SOIs forms a layer within a single SOI.

The vertical relationship structure creation unit 113 creates the SOIs as the vertical relationship structure so that at least one other location information can be included in a single location information, so that at least one lower SOI is located within the single SOI.

For example, a single SOI can be created so that building 1 and building 2 are included in region A. That is, region A is created as an upper SOI and building 1 and building 2 are each managed as lower SOIs of the upper SOI.

The horizontal relationship structure creation unit 114 creates the SOIs into a horizontal relationship structure so that the plurality of SOIs are horizontally located without a hierarchy.

For example, the horizontal relationship structure creation unit 114 can create the SOIs so that region B, building 1, and building 2 are horizontally linked with one another. That is, region B, building 1, and building 2 are each created as an SOI and are managed so as to be linked with one another.

The floor relationship structure creation unit 114 creates and manages the SOIs so that a plurality of floors can be included in a single region or building, that is, a plurality of SOIs can form floors within a single SOI.

For example, the floor relationship structure creation unit 114 can create an SOI so that the plurality of SOIs are structured to form floors of SOIs within a single building. That is, a single building is created as an upper SOI and each layer is divided into lower SOIs of the upper SOI. Each SOI is managed separately.

The shape information creation unit 116 creates the shape information that is substantial images, such as point, line, and region information, building information, or the like, on the location information and manages the shape information in an SOI unit. For example, the region can be imaged in the SOI unit, a building can be imaged within the region in the SOI unit, and components within the building can be imaged in the SOI unit.

The identifier information creation unit 117 creates and manages the identification information to the SOI created in the location information creation unit 112 according to each structure. The identifier information creation unit 117 allocates an SOI identifier sign when the single SOI is created to manage the information in the SOI unit.

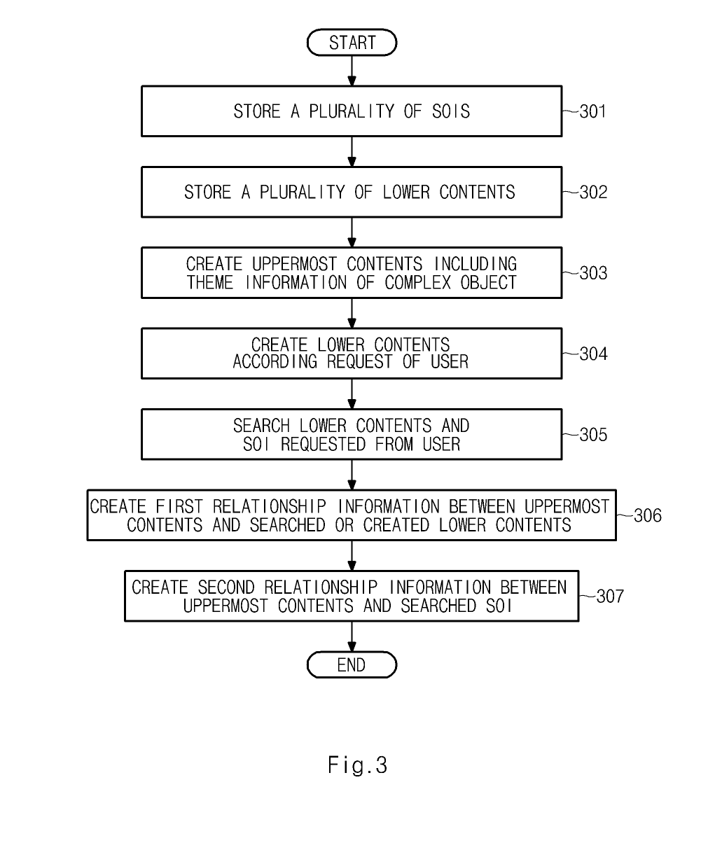

FIG. 3 is a flow chart of a method for creating a complex SOI object and contents according to an embodiment of the present invention.

The SOI storage unit 10 first stores information on a space including location information, shape information, and identifier information (301) (i.e., SOI).

Further, the lower content storage unit 20 stores a plurality of lower contents (302).

Thereafter, the uppermost content creation unit 30 creates the uppermost contents including theme information of a complex object (303).

Thereafter, the lower content creation unit 40 creates the lower contents according to a user's request.

Thereafter, the relationship information creation unit 50 searches for the lower contents and the SOI as requested by a user in the lower content storage unit and the SOI storage unit (305).

Thereafter, the relationship information creation unit 50 creates the first relationship information between the uppermost content created in the uppermost content creation unit 30 and the searched or created lower content (306).

In addition, the relationship information creation unit 50 can create the second relationship information between the uppermost content created in the uppermost content creation unit 30 and the searched SOI (307).

Through this process, the link scalability of the contents for the SOI can be increased.

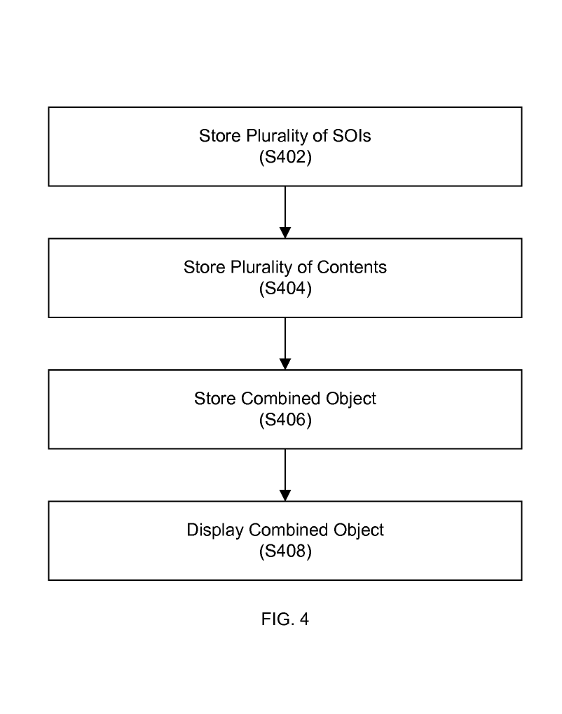

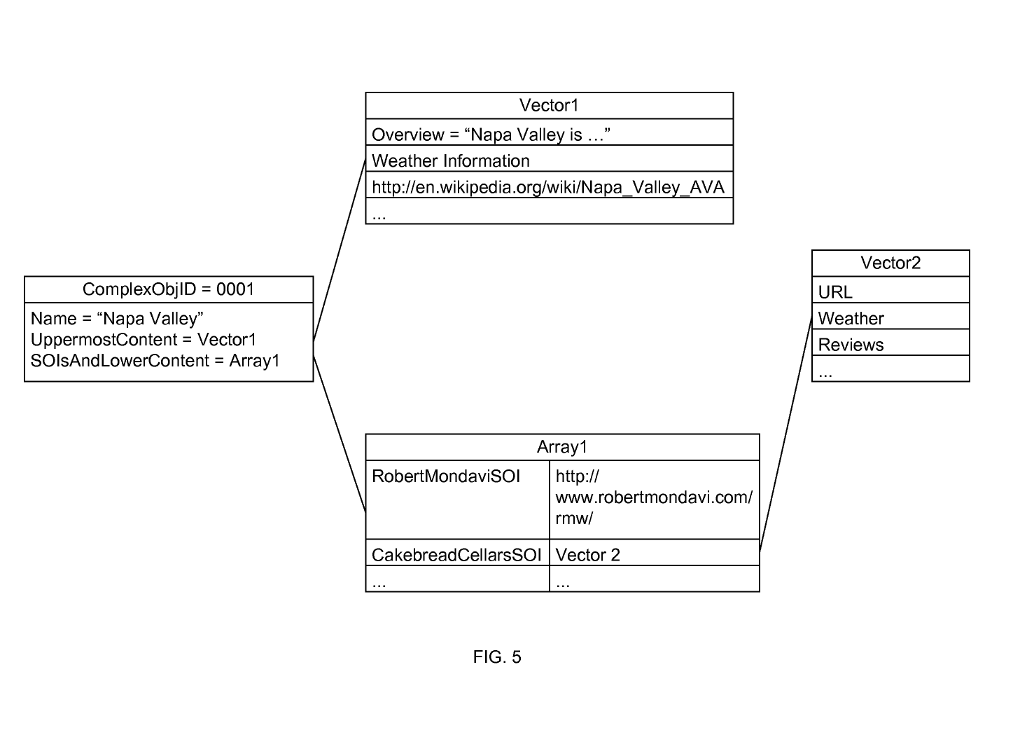

Referring now to FIGS. 4 and 5, another embodiment of the invention provides a method of generating a complex object 400, which is further illustrated through an exemplary implementation of a complex object for a Napa Valley wine tour.

In step S402, a plurality of SOIs are stored. For example, the SOIs can be stored as entries in database tables, files, objects, and the like.

In step S404, a plurality of contents are stored. The contents can be any type of information pertaining to SOIs.

In step S406, a complex object is stored. The complex object can define a plurality of relationships between itself and a subset of the plurality of contents. The complex object can also associate SOIs with contents. For example, a first SOI can be associated with a first content so that a URL for the Robert Mondavi Winery is associated with the appropriate SOI. Likewise, multiple contents can be associated with a single SOI so that, for example, a URL, user reviews, and weather can be associated with the SOI for a particular winery.

As discussed above, in addition to establishing relationships between SOIs and contents, the complex object can also establish relationships between the complex object itself and content (referred to herein as upper contents). For example, in addition to associating individual wineries with content pertaining to the individual wineries, the complex object can include general information regarding Napa Valley such as weather information, traffic information, regional events, a WIKIPEDIA® entry on the Napa Valley American Viticultural Region, and the like.

In step S408, the combined object can be displayed (e.g., on a display device such as a smartphone, computer monitor, navigation system, and the like). The combined object can be depicted as text and/or graphics. For example, a textual depiction can display the theme, followed by content associated directly with the complex object, followed by content associated with the SOIs that are associated with the complex object. In this manner, a dynamic text document can be produced and maintained. In another example, a map can be displayed that depicts all or a subset of the SOIs associated with the complex object. Content associated with the displayed SOIs can also be shown (e.g., to the side of the map). The map can be manipulated using various known techniques. As the map is manipulated (e.g., to pan or zoom), the subset of displayed SOIs can change and the displayed textual information can change as well to reflect the displayed subset of SOIs.

The scope of a complex object can be defined, for example, by a user. Accordingly, the user can affirmatively designate which SOIs and/or contents will be associated with the complex object. Such selection can limit the scope of the complex object to a certain depth. For example, even though the URL, weather, and reviews in Vector2 in FIG. 5 can be associated with still more content and/or SOIs, the user can specify that the complex object will not extend beyond Vector2. Such a feature can advantageously prevent the display of excessive information to the user or limit the associated information to a scope that the user can personally verify.

As set forth above, the exemplary embodiments of the present invention can increase the link scalability of SOI and contents by creating the second relationship information between one space of interest (SOI) including location information, shape information, and identifier information and contents having the first relationship information with other contents or other SOIs.

Although the present invention has been described with reference to exemplary embodiments and the accompanying drawings, it would be appreciated by those skilled in the art that the present invention is not limited thereto but various modifications and alterations might be made without departing from the scope defined in the claims and their equivalents. For example, one of ordinary skill in the art will recognize that the inventions can be implemented computers and/or in computer-readable media. A “computer readable medium” shall be understood to mean any article of manufacture that contains data that can be read by a computer or a carrier wave signal carrying data that can be read by a computer. Such computer readable media includes, but is not limited to, magnetic media, such as a floppy disk, a flexible disk, a hard disk, reel-to-reel tape, cartridge tape, cassette tape or cards; optical media such as CD-ROM and writeable compact disc; magneto-optical media in disc, tape or card form; paper media, such as punched cards and paper tape; or on carrier wave signal received through a network, wireless network or modem, including radio-frequency signals and infrared signals.

What is claimed is:

1. An apparatus for creating a combined SOI object and contents, comprising:
a first creation unit creating uppermost contents including theme information of the combined SOI object;
an SOI storage unit storing information on a space including location information, shape information, and identifier information;
a lower content storage unit storing a plurality of lower contents;
a second creation unit creating lower contents according to a request by a user; and
a relationship information creating unit searching the lower contents and the SOI requested by the user in the lower content storage unit and the SOI storage unit and then creating a first relationship information between the uppermost contents and the searched or created lower contents and creating a second relationship information between the uppermost contents and the searched SOI.

2. The apparatus of claim 1, wherein the lower contents are linked with at least one other contents or SOIs.

3. The apparatus of claim 2, wherein the relationship information creation unit creates third relationship information between the lower contents and other contents or fourth relationship information between the lower contents and the SOIs.

4. The apparatus of claim 1, wherein the SOI is linked with at least one other contents or other SOIs.

5. The apparatus of claim 4, wherein the relationship information creation unit creates fifth relationship information between the SOI and other contents or sixth relationship information between the SOI and other SOIs.

6. A method for creating a complex object of SOI and contents, comprising:
storing information on a space including location information, shape information, and identifier information;
storing a plurality of lower contents;
creating uppermost contents including theme information of the complex object; and
searching the lower contents and the SOI requested in the lower content storage unit and the SOI storage unit and then, creating first relationship information between the uppermost contents and the searched or created lower contents and creating second relationship information between the uppermost contents and the searched SOI.

7. The method of claim 6, wherein the lower contents are linked with at least one other content or SOI.

8. The method of claim 7, further comprising creating, by the relationship information creation unit, third relationship information between the lower contents and other contents or fourth relationship information between the lower contents and the SOIs.

9. The method of claim 6, wherein the SOI is linked with at least one other contents or other SOIs.

10. The method of claim 9, further comprising creating, by the relationship information creation unit, a fifth relationship information between the SOI and other contents or a sixth relationship information between the SOI and other SOIs.

11. A method of generating a complex object of spaces of interest (SOIs) and contents, the method comprising:
storing a plurality of SOIs;
storing a plurality of contents; and
storing a complex object that defines a plurality of relationships between the complex object and a subset of the plurality of contents.

12. The method of claim 11, further comprising:
displaying the complex object such that the displayed complex object displays at least a portion of the subset of the plurality of the contents.

13. The method of claim 11, further comprising:
storing a plurality of relationships between one or more of the SOIs and one or more of the contents;
displaying a map along with the complex object, the map encompassing an displayed area including one or more SOIs associated with the plurality of the contents;
receiving instructions to modify the displayed area of the map; and
updating the displayed complex object to display only contents from the subset of contents that are associated with the SOIs within the displayed area.

14. The method of claim 11, wherein the complex object represents a theme.

15. The method of claim 11, further comprising:
displaying at least a portion of the complex object when one of either the contents of the subset or the SOIs associated with the contents of the subset is displayed.

16. A computer program product for causing a computer to perform a method for creating a complex object of SOI and contents, the computer program product comprising computer-usable medium having control logic stored therein that, when executed by a processor, is operable to:
store information on a space including location information, shape information, and identifier information;
store a plurality of lower contents;
create uppermost contents including theme information of the complex object; and
search the lower contents and the SOI requested in the lower content storage unit and the SOI storage unit and then, create first relationship information between the uppermost contents and the searched or created lower contents and create second relationship information between the uppermost contents and the searched SOI.

17. A computer program product for causing a computer to perform a method of generating a complex object of spaces of interest (SOIs) and contents, the computer program product comprising computer-usable medium having control logic stored therein that, when executed by a processor, is operable to:
store a plurality of SOIs;
store a plurality of contents; and
store a complex object that defines a plurality of relationships between the complex object and a subset of the plurality of contents.
